(19) United States
(12) Patent Application Publication
(10) Pub. No.: US 2005/0218812 A1
(43) Pub. Date: Oct. 6, 2005

(54) Low-pressure mercury vapor discharge lamp and compact fluorescent lamp

(76) Inventors: Ronald Arjan Van Den Brakel, Roosendaal (NL); Ingrid Jozef Maria Snijkers-Hendrickx, Eindhoven (NL); Willem Johannes Van den Bogert, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/516,143

(22) PCT Filed: May 21, 2003
(86) PCT No.: PCT/IB03/02249

§ 371 Date: Nov. 30, 2004

(30) Foreign Application Priority Data
Jun. 4, 2002 (EP) 02077216.6

(51) Int. Cl. H01J 17/20; H01J 61/20

(52) U.S. Cl. 313/642

(57) ABSTRACT

A low-pressure mercury vapor discharge lamp has a light-transmitting discharge vessel (10), enclosing, in a gastight manner, a discharge space (11) provided with a filling of mercury and a rare gas. The discharge vessel (10) comprises means (41a) for maintaining a discharge in the discharge space (11). At least a part of an inner wall of the discharge vessel (10) is provided with a protective translucent layer (16). According to the invention, the discharge vessel (10) is provided with a pinched seal (20). In addition, the translucent layer (16) comprises a borate and/or a phosphate of an alkaline earth metal and/or of scandium, yttrium or a further rare earth metal. Preferably, the glass composition is made from a sodium-rich glass including the following constituents: 70-75 wt. % SiO2, 15-18 wt. % Na2O, 0.25-2 wt. % K2O. The discharge lamp according to the invention has a comparatively high maintenance.

The invention relates to a low-pressure mercury vapor discharge lamp comprising a light-transmitting discharge vessel,

the discharge vessel enclosing, in a gastight manner, a discharge space provided with a filling of mercury and a rare gas,

the discharge vessel comprising means for maintaining a discharge in the discharge space,

while at least a part of an inner wall of the discharge vessel is provided with a translucent layer.

The invention also relates to a compact fluorescent lamp.

In mercury vapor discharge lamps, mercury constitutes the primary component for the (efficient) generation of ultraviolet (UV) light. A luminescent layer comprising a luminescent material (for example, a fluorescent powder) may be present on an inner wall of the discharge vessel to convert UV to other wavelengths, for example, to UV-B and UV-A for tanning purposes (sun panel lamps) or to visible radiation for general illumination purposes. Such discharge lamps are therefore also referred to as fluorescent lamps. The discharge vessel of low-pressure mercury vapor discharge lamps is usually tubular and circular in section and comprises both elongated and compact embodiments. Generally, the tubular discharge vessel of so-called compact fluorescent lamps comprises a collection of relatively short straight parts having a relatively small diameter, which straight parts are connected together by means of bridge parts or arc-shaped parts. Compact fluorescent lamps are usually provided with an (integrated) lamp cap.

In the description and claims of the current invention, the designation “nominal operation” is used to refer to operating conditions where the mercury-vapor pressure is such that the radiation output of the lamp is at least 80% of that during optimum operation, i.e. under operating conditions where the mercury-vapor pressure is optimal. In addition, in the description and claims, the “initial radiation output” is defined as the radiation output of the discharge lamp 1 second after switching on the discharge lamp, and the “run-up time” is defined as the time needed by the discharge lamp to reach a radiation output of 80% of that during optimum operation.

It is known that measures are taken in low-pressure mercury vapor discharge lamps to inhibit blackening of parts of the inner wall of the discharge vessel, which parts are in contact with a discharge which, during operation of the discharge lamp. Such blackening, which is brought about by interaction between mercury and the material from which the inner wall of the discharge vessel is made, is undesirable and does not only lead to a reduction of the maintenance but also to an unaesthetic appearance of the lamp, particularly because the blackening occurs irregularly, for example, in the form of dark stains or dots.

A low-pressure mercury vapor discharge lamp of the type described in the opening paragraph is known from U.S. Pat. No. 4,544,997. In the known discharge lamp, an oxide selected from the group formed by yttrium, scandium, lanthanum, gadolinium, ytterbium and lutetium is used as the translucent layer. The oxide is provided as a thin layer on the inner wall of the discharge vessel. The known translucent layers are colorless, hardly absorb UV radiation or visible light and satisfy the requirements with respect to light and radiation transmissivity. The use of the known translucent layers causes blackening and discoloring of the inner wall of the discharge vessel of the low-pressure mercury vapor discharge lamp to be reduced.

A drawback of the use of the known low-pressure mercury vapor discharge lamp is that the maintenance still is relatively poor due to said blackening. As a result, in addition, a relatively large amount of mercury is necessary for the known lamp in order to realize a sufficiently long service life. In the case of injudicious processing after the end of the service life, this is detrimental to the environment.

It is an object of the invention to eliminate the above disadvantage wholly or partly. According to the invention, a low-pressure mercury vapor discharge lamp according to the invention is characterized in that the discharge vessel is provided with a pinched seal, and in that the translucent layer comprises a borate and/or a phosphate of an alkaline earth metal and/or of scandium, yttrium or a further rare earth metal. A discharge vessel of a low-pressure mercury vapor discharge lamp according to the invention having a pinched seal and comprising a transparent layer including said borate and/or phosphate appears to be very well resistant to the action of the mercury-rare gas atmosphere which, in operation, prevails in the discharge vessel of the low-pressure mercury vapor discharge lamp. As a result, blackening due to interaction between mercury and the glass from which the discharge vessel is manufactured is reduced, resulting in an improvement of the maintenance. During the service life of the discharge lamp, a smaller quantity of mercury is withdrawn from the discharge, so that, in addition, a reduction of the mercury consumption of the discharge lamp is obtained and in the manufacture of the low-pressure mercury vapor discharge lamp a smaller mercury dose will suffice.

Wall blackening caused by withdrawing mercury from the discharge occurs in straight parts as well as in arc-shaped parts of low-pressure mercury vapor discharge lamps and in the sealing areas of the discharge vessel. In the known discharge lamp, the means for maintaining a discharge in the discharge space are electrodes. The electrodes are supported by an (indented) end portion (also called “stem”) of the discharge vessel. Current supply conductors issue from each electrode through the end portions of the discharge vessel to the exterior. In order to obtain a proper seal when mounting the end portions, it is necessary in the known discharge vessel to clean the discharge vessel in the vicinity of the end portions from coatings present on the inside of the discharge vessel. The phosphor coating is normally removed from the sealing areas (end portion(s)) as well as protective coatings made of alumina particles. As a consequence, said parts of the discharge vessel in the vicinity of the end portions are sensitive to an attack by the mercury atmosphere in the discharge lamp, during operation, and substantial wall blackening occurs in the discharge vessel in the vicinity of the end portions. By applying a protective translucent layer according to the invention in combination with a pinched seal in accordance with the invention causes blackening to be substantially reduced in the parts of the discharge vessel in the vicinity of the end portions. In principle, the entire inner wall surface of the discharge vessel is coated with the protective translucent layer thereby preventing wall blackening of the discharge vessel. Advantage of the use of the translucent layer according to the invention is that the materials can also be applied at the part of the wall of the discharge vessel where, during manufacturing of the low-pressure mercury vapor discharge lamp pinched seal is formed.

A preferred embodiment of the low-pressure mercury vapor discharge lamp according to the invention is characterized in that, the pinched seal comprises material from the translucent layer. Because it is no longer necessary to clean the discharge vessel in the vicinity of the pinched seal (apart from removing the luminescent material), material from the translucent layer can be found in the pinched seal.

Another preferred embodiment of the low-pressure mercury vapor discharge lamp according to the invention is characterized in that, the means for maintaining a discharge comprises an electrode pair arranged in the discharge space and that current supply conductors issue from the electrode pair through the pinched seal of the discharge vessel to the exterior. In this embodiment the pinched seal also functions as feed through for the current supply conductors.

A preferred embodiment of the low-pressure mercury vapor discharge lamp according to the invention is characterized in that, the translucent layer comprises an alkaline earth borate, and in that the thickness of the translucent layer is in the range from 0.1-50 μm. By employing a translucent layer of alkaline earth borate and with a thickness in the range given above appears to be very well resistant to the action of the mercury-rare gas atmosphere which, in operation, prevails in the discharge vessel of the low-pressure mercury vapor discharge lamp. The inventors have had the insight that by using a suspension of “nano-particles” of alkaline earth borates, in particular calcium, strontium and/or barium borate, a translucent layer can be made with a thickness which can be significantly larger than that of the translucent layer made out of a solution of the salts in the known discharge lamp. With “nano-particles” in the description of the present invention it is meant that particles with a particle size in the range from 0.1-1 μm. The softening point of the calcium, strontium and/or barium borate particulate material is low enough that the particles melt together during the bending glass shaping. In addition, a dense translucent layer is obtained that, because of its large thickness, has not completely reacted with the underlying wall of the discharge vessel in the bents and in the seal. In experiments it was found that a translucent layer made from nano-particles of calcium, strontium and/or barium borate showed a relatively high point of zero charge and a relatively low mercury consumption. An additional advantage of producing the translucent layer from nano-particles of alkaline earth borates is that the size of the particles of alkaline earth borates is comparable to the wavelength of the UV light. This makes it possible to employ the translucent layer also as a reflector for UV light (the size of the particles is in the range from approximately 0.3 μm to approximately 0.6 μm). Preferably, the translucent layer comprises SrB₄O₇. Preferably, nano-particles of SrB₄O₇ with a particle size in the range from approximately 0.1 to approximately 1 μm are used to manufacture the translucent layer according to the invention.

Preferably, the thickness of the translucent layer is in the range from 10-20 μm. Upon making the translucent layer thinner than approximately 10 μm could, in particular during bending glass shaping of discharge vessels under factory conditions, give rise to a possible complete reaction of the particulate calcium, strontium and/or barium borate with the wall. The risk is higher in a production environment where the conditions can not always be met as precisely as in laboratory experiments. It is observed that in the straight parts of the discharge vessel of compact fluorescent lamps, the particles in the translucent layer do not reach a high enough temperature to melt leading to diffuse scattering of light in the translucent layer. In the arc-shaped parts of the discharge vessel of compact fluorescent lamps, the particles in the translucent layer reach a high enough temperature to melt leading to a transparent layer.

A preferred embodiment of the low-pressure mercury vapor discharge lamp according to the invention is characterized in that the discharge vessel is made from a glass comprising silicon dioxide and sodium oxide, with the glass composition comprising the following essential constituents, given in percentages by weight (wt. %): 60-80 wt. % SiO₂ and 10-20 wt. % Na₂O. The application of a sealed pinch and a translucent layer according to the invention in combination with the sodium-rich glass in accordance with the invention causes blackening to be substantially reduced in the vicinity of the pinch of the discharge vessel. The invention is in particular embodied in a combination of a discharge vessel with a pinched pin seal, a coating comprising the borate and/or phosphate as described above and sodium-rich glass.

Sodium-rich glasses are comparatively inexpensive. In the known discharge lamp use is made of a so-called mixed alkali glass having a comparatively small SiO₂ content (approximately 67% as compared to approximately 72% for the sodium-rich glass) and comprising, inter alia, approximately 8 wt. % Na₂O and 5 wt. % K₂O. The cost price of said glass is comparatively high. A comparison between the composition of the known glass and the sodium-rich glass shows that the alkali content is different. The sodium-rich glass has a comparatively low potassium content, while the known glass is a so-called mixed alkali glass having an approximately equal molar ratio of Na₂O and K₂O. An advantage resides in that the mobility of the alkali ions in the sodium-rich glass is comparatively high with respect to the mobility in the mixed alkali glass. The run-up time for low-pressure mercury vapor discharge lamps made from sodium-rich glass is approximately the same as for discharge vessels made from the known mixed alkali glass.

The translucent layer in the low-pressure mercury-vapor discharge lamp in accordance with the invention further satisfies the requirements with respect to light and radiation transmissivity and can be easily provided as a very thin, closed and homogeneous translucent layer on an inner wall of a discharge vessel of a low-pressure mercury vapor discharge lamp. This is effected, for example, by rinsing the discharge vessel with a solution of a mixture of suitable metal-organic compounds (for example, acetonates or acetates, for example, scandium acetate, yttrium acetate, lanthanum acetate or gadolinium acetate mixed with calcium acetate, strontium acetate or barium acetate) and boric acid or phosphoric acid diluted in water, while the desired translucent layer is obtained after drying and sintering.

A preferred embodiment of the low-pressure mercury vapor discharge lamp according to the invention is characterized in that a side of the translucent layer facing the discharge space is provided with a layer of a luminescent material. An advantage of the use of a translucent layer according to the invention in low-pressure mercury vapor discharge lamps is that the luminescent layer comprising a luminescent material (for example, a fluorescent powder) adheres significantly better to such a translucent layer than to a translucent layer of the known low-pressure mercury vapor discharge lamp. Said improved adhesion is obtained particularly in the arc-shaped parts of low-pressure mercury-vapor discharge lamps.

The measure according to the invention is notably suitable for compact fluorescent lamps having arc-shaped lamp parts, wherein the discharge vessel is additionally surrounded by a light-transmitting envelope. The temperature of the discharge vessel of such “covered” compact fluorescent lamps is comparatively high because the heat dissipation to the environment is reduced by the presence of the outer envelope. This unfavorable temperature balance adversely affects the maintenance of the known discharge lamp due to an increased level of blackening. In experiments it has surprisingly been found that the maintenance of a compact fluorescent lamp provided with a low-pressure mercury vapor discharge lamp according to the invention, the discharge vessel of which is surrounded by an envelope, has 90% maintenance after 12,000 burning hours, while the maintenance of an identical compact fluorescent lamp provided with the known low-pressure mercury vapor discharge lamp, the discharge vessel of which is surrounded by an envelope, is less than 80% after 12,000 burning hours and fluctuates (depending on the amount of Hg consumption consumed). The depletion of mercury out of the amalgam can be so high that the amalgam does no longer give the optimum mercury pressure. In addition, the light output drops significantly.

The glass composition preferably includes the following constituents: 70-75 wt. % SiO₂, 15-18 wt. % Na₂O, and 0.25-2 wt. % K₂O. The composition of such a sodium-rich glass is similar to that of ordinary window glass and it is comparatively cheap with respect to the glass used in the known discharge lamp. The cost price of the raw materials for the sodium-rich glass as used in the discharge lamp in accordance with the invention is only approximately 50% of the cost price of the raw materials for the mixed alkali glass as used in the known discharge lamp. Moreover, the conductance of said sodium-rich glass is comparatively low; at 250° C. the conductance is approximately log ρ=6.3 while the corresponding value of the mixed alkali glass is approximately log ρ=8.9.

In a preferred embodiment of the low-pressure mercury vapor discharge lamp according to the invention, the translucent layer comprises a borate and/or a phosphate of calcium, strontium and/or barium. Such a translucent layer has a relatively high coefficient of transmission for visible light. Moreover, low-pressure mercury vapor discharge lamps with a translucent layer comprising calcium borate, strontium borate or barium borate or calcium phosphate, strontium phosphate or barium phosphate have a good maintenance.

In a particularly preferred embodiment of the low-pressure mercury vapor discharge lamp according to the invention, the translucent layer comprises an yttrium-strontium-borate composition. Such a translucent layer has a relatively high coefficient of transmission for ultraviolet radiation and visible light. It has further been found that a translucent layer comprising yttrium borate and strontium borate is only slightly hygroscopic and adheres well to the inner wall of the discharge vessel. Moreover, the layer can be provided in a relatively simple manner (for example, with yttrium acetate and strontium acetate mixed with boric acid), which has a cost-saving effect, notably useful in a mass manufacturing process for low-pressure mercury vapor discharge lamps.

These and other aspects of the invention will be apparent from and elucidated with reference to the embodiments described hereinafter.

In the drawings:

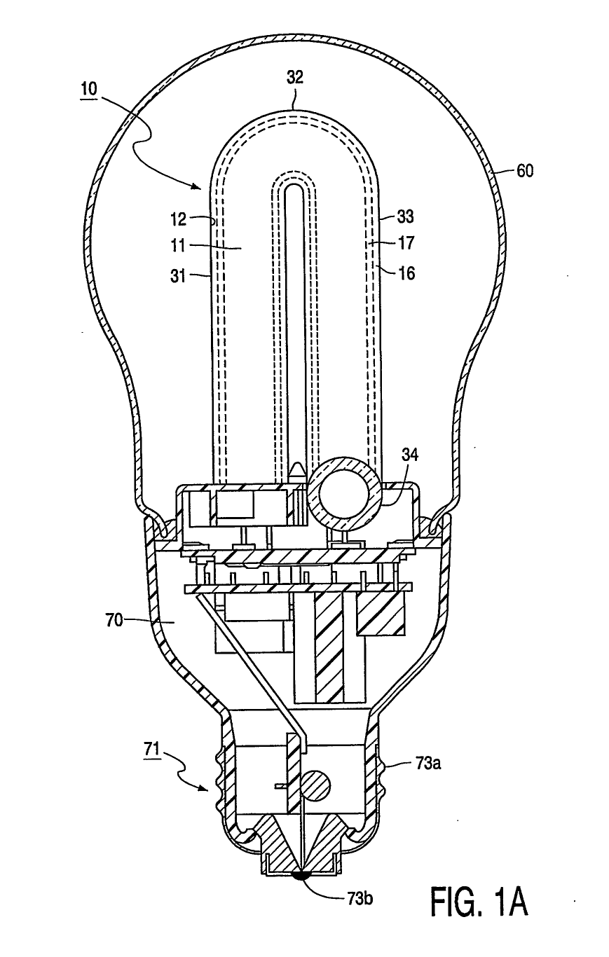

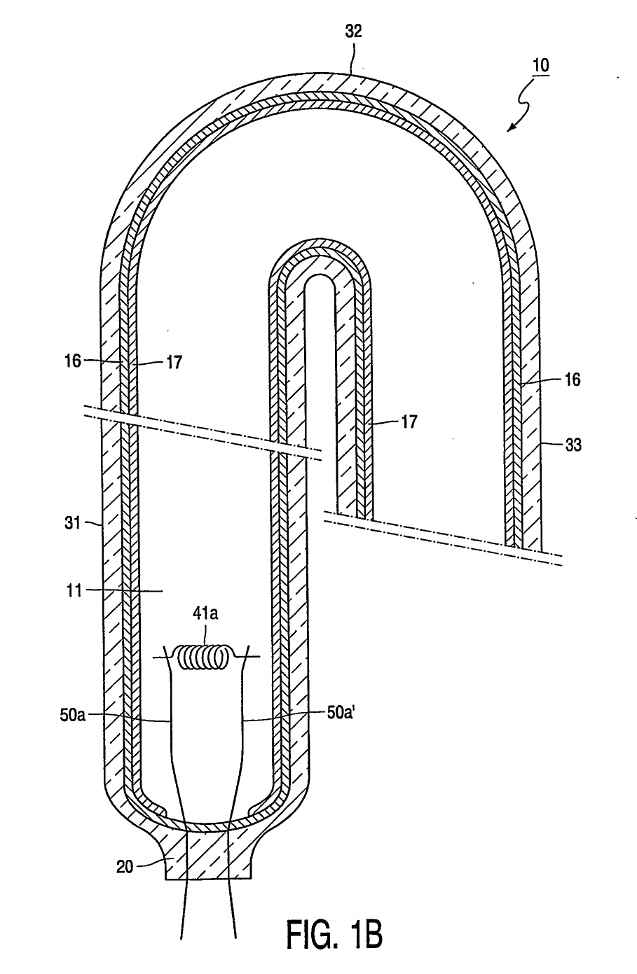

FIG. 1A is a cross-sectional view of an embodiment of a compact fluorescent lamp comprising a low-pressure mercury vapor discharge lamp according to the invention, and

FIG. 1B is a cross-sectional view of a detail of the low-pressure mercury vapor discharge lamp as shown in FIG. 1A.

The Figures are purely diagrammatic and not drawn to scale. Particularly for clarity, some dimensions are exaggerated strongly. Similar components in the Figures are denoted by the same reference numerals as much as possible.

FIG. 1A shows a compact fluorescent lamp comprising a low-pressure mercury vapor discharge lamp. The low-pressure mercury-vapor discharge lamp is provided with a radiation-transmitting discharge vessel 10 enclosing a discharge space 11 having a volume of approximately 10 cm³. The discharge vessel 10 is a glass tube which is at least substantially circular in cross-section and the (effective) internal diameter of which is approximately 10 mm. The discharge vessel 10 is closed in a gastight manner by a pinched seal 20 according to the invention (see FIG. 1B). The pinched seal 20 is made by press sealing. The tube is bent in the form of a so-called hook and, in this embodiment, it has a number of straight parts, two of which, referenced 31, 33, are shown in FIG. 1A. The discharge vessel further comprises a number of arc-shaped parts, two of which, referenced 32, 34, are shown in FIG. 1A. An inner wall 12 of the discharge vessel 10 is provided with a translucent layer 16 and with a luminescent layer 17. In an alternative embodiment, the luminescent layer has been omitted. The use of a pinched seal 20 and the application of the bendable translucent layer 16 according to the invention enables the entire surface area of the inner wall 12 of the discharge vessel 10 to be coated with the protective translucent layer 16. The inventive combination of the pinched seal 20 and the application of the bendable translucent layer 16 according to the invention allows the use of sodium-rich glass as material for the discharge vessel. Particularly preferred is a glass of the following composition: 70-74 wt. % SiO₂, 16-18 wt. % Na₂O, 0.5-1.3 wt. % K₂O, 4-6 wt. % CaO, 2.5-3.5 wt. % MgO, 1-2 wt. % Al₂O₃, 0-0.6 wt. % Sb₂O₃, 0-0.15 wt. % Fe₂O₃ and 0-0.05 wt. % MnO. Excellent run-up characteristics are obtained for low-pressure mercury vapor discharge lamps made from sodium-rich glass.

The discharge vessel 10 is supported by a housing 70 which also supports a lamp cap 71 provided with electrical and mechanical contacts 73a, 73b, which are known per se. The discharge vessel 10 of the low-pressure mercury-vapor discharge lamp is surrounded by a light-transmitting envelope 60 which is attached to the lamp housing 70. The light-transmitting envelope 60 generally has a matt appearance.

FIG. 1B very diagrammatically shows a cross-sectional view of a detail of the low-pressure mercury-vapor discharge lamp shown in FIG. 1A. The discharge space 11 in the discharge vessel 10 does not only comprise mercury but also a rare gas, argon in this example. Means for maintaining a discharge are constituted by an electrode pair 41a (only one electrode is shown in FIG. 1B) which is arranged in the discharge space 11. In an alternative embodiment the low-pressure mercury vapor discharge lamp is a so-called electrode-less discharge lamp. The electrode 41a in FIG. 1B is a winding of tungsten coated with an electron-emissive material, here a mixture of barium oxide, calcium oxide and strontium oxide. Current supply conductors 50a, 50a′ issue from the electrode pair 41a through the pinched seal 20 end portions of the discharge vessel 10 to the exterior. The electrode 41a is supported by the pinched seal 20 which seal closes the discharge vessel 10 in a gastight manner. The current supply conductors 50a, 50a′ are connected to an (electronic) power supply which is accommodated in the housing 70 and electrically connected to the electrical contacts 73b at the lamp cap 71 (see FIG. 1A).

In an embodiment of the low-pressure mercury vapor discharge lamp, various concentrations of an Sr(Ac)₂ (strontium acetate) solution and H₃BO₃ (boric acid) are added to solutions comprising various concentrations of Y(Ac)₃ (yttrium acetate) to manufacture the translucent layer 16 according to the invention. In an alternative embodiment, a Ba(Ac)₂ (barium acetate ) solution is added instead of an Sr(Ac)₂ solution. Three recipes were tested, as shown in Table I.

TABLE I
Three recipes for a translucent layer.

| Recipe | wt. % Y(Ac)₃ | mol Sr(Ac)₂ | mol H₃BO₃ |
|---|---|---|---|
| R₁ | 0.11 | 0.036 | 0.147 |
| R₂ | 0.15 | 0.06 | 0.24 |
| R₃ | 0.15 | 0.048 | 0.191 |

Before coating, the discharge vessels were bent in the known hook shape having straight parts and arcuate parts. In an alternative embodiment, the bending took place after coating the discharge vessel. After rinsing and drying, the discharge vessels were provided with a coating by passing an excess of the afore-mentioned solutions through the discharge vessels. After said coating operation, the discharge vessels were first dried in air at a temperature of approximately 60° C. for 15 minutes and subsequently sintered at approximately 550° C. for 2 minutes. In an alternative embodiment, the translucent coating is fixed in a shorter period of time at a higher temperature.

In a preferred embodiment of the low-pressure mercury vapor discharge lamp, so-called nano-particles of SrB₄O₇ with a particle size in the range from approximately 0.1 to approximately 1 μm are used to manufacture the translucent layer 16 according to the invention. Stoichiometric quantities of SrCO₃ and H₃BO₃ are mixed and melted in a Pt-crucible in air. After cooling down, the glass is crushed and milled with butyl acetate during two hours followed by 48 hours rolling with ZrO₂ spheres. The resulting amorphous particles of SrB₄O₇ have an average particle size of 0.6 μm. After proving the discharge vessels with such a coating, the discharge vessels were first dried in air at a temperature of approximately 60° C. for 15 minutes. In an alternative embodiment, the transparent coating is fixed in a shorter period of time at a higher temperature. The thickness of the translucent layer 16 ranges from approximately 1 μm to approximately 50 μm, preferably from approximately 10 μm to approximately 20 μm. In an alternative embodiment, nano-particles of BaB₄O₇ or CaB₄O₇ are employed.

Subsequently, the discharge vessels were provided with a luminescent coating comprising three known phosphors, namely a green-luminescent material with terbium-activated cerium magnesium aluminate, a blue-luminescent material with bivalent europium-activated barium magnesium aluminate, and a red-luminescent material with trivalent europium-activated yttrium oxide. A number of said discharge vessels were subsequently assembled to low-pressure mercury vapor discharge lamps in the customary manner. A number of these discharge lamps were subsequently provided with a translucent envelope on the basis of one of the three recipes mentioned hereinabove (see the example shown in FIG. 1A). Experiments were carried out on discharge vessels of two lengths, namely 230 mm (11W fluorescent lamp) and 405 mm (20W fluorescent lamp). The current intensity of the lamp during operation was 200 mA in all cases.

Subsequently, the maintenance after 1,000 hours has been measured of low-pressure mercury-vapor discharge lamps comprising a discharge vessel in accordance with the invention and provided with the R3 composition of the translucent layer in accordance with the invention. For comparison, the maintenance of discharge vessels with the standard seal and a transparent layer of known yttrium oxide is given. The results of these measurements are shown in Table II.

TABLE II
Maintenance data (1000 hours) of low-pressure mercury-vapor
discharge lamps comprising a discharge vessel with a pinched
seal and made from sodium-rich glass and provided with the R3
composition of the translucent layer in accordance with the invention.
For comparison, the maintenance of discharge vessels with the
standard seal and a transparent layer of known yttrium oxide is given.

| | Known glass | Sodium-rich glass |
|---|---|---|
| | No pinched seal | With pinched seal |
| | Known Y₂O₃ translucent | Translucent layer from |
| | layer | R3 composition |
| No pinched seal | 95 (4) | 66 (18) |
| With pinched seal | 95 (4) | 95 (6) |

Table II shows that after 1,000 hours the maintenance of discharge lamps comprising the discharge vessel with a pinched seal and made from sodium-rich glass and provided with the translucent layer according to the invention is relatively high. Up to 12,000 hours there is no significant difference in maintenance with the known glass and without a pinched seal between the three compositions of the translucent layer in accordance with the invention.

In Table III the amount of bound mercury (in μg) in the discharge vessel after 1000 hours life time of low-pressure mercury-vapor discharge lamps comprising a discharge vessel with a pinched seal and made from sodium-rich glass and provided with the R3 composition of the translucent layer (see Table I). For comparison, the date for discharge vessels with the standard seal are given.

TABLE III
Bound mercury (Hg) in the discharge vessel after 1000 hours life time
of low-pressure mercury-vapor discharge lamps comprising a discharge
vessel with a pinched seal and made from sodium-rich glass and
provided with the R3 composition of the translucent layer in accordance
with the invention. For comparison, the date for discharge vessels
with the standard seal is given.

| Known glass | Sodium-rich glass | Sodium-rich glass |
|---|---|---|
| No pinched seal | No pinched seal | With pinched seal |
| Known Y₂O₃ | Translucent layer from | Translucent layer from |
| translucent layer | R3 composition | R3 composition |
| 110 μg Hg | 922 μg Hg | 100 μg Hg |

The relatively high Hg consumption of the discharge vessel made of sodium rich glass and without a sealed pinch is mainly located in the seal area.

It will be evident that within the scope of the invention many variations are possible to those skilled in the art.

The scope of protection of the invention is not limited to the examples given herein. The invention is embodied in each novel characteristic and each combination of characteristics. Reference numerals in the claims do not limit the scope of protection of the claims. The word “comprising” does not exclude the presence of elements other than those mentioned in the claims. The use of the word “a” or “an” in front of an element does not exclude the presence of a plurality of such elements.

1. A low-pressure mercury vapor discharge lamp comprising a light-transmitting discharge vessel,
the discharge vessel enclosing, in a gastight manner, a discharge space provided with a filling of mercury and a rare gas,
the discharge vessel comprising means for maintaining a discharge in the discharge space,
while at least a part of an inner wall of the discharge vessel is provided with a translucent layer, characterized
in that the translucent layer comprises a borate and/or a phosphate of an alkaline earth metal and/or of scandium, yttrium or a further rare earth metal, and
in that the discharge vessel is provided with a pinched seal.

2. A low-pressure mercury vapor discharge lamp as claimed in claim 1, characterized in that the pinched seal comprises material from the translucent layer.

3. A low-pressure mercury vapor discharge lamp as claimed in claim 1, characterized in that the means for maintaining a discharge comprises an electrode pair arranged in the discharge space and that current supply conductors issue from the electrode pair through the pinched seal of the discharge vessel to the exterior.

4. A low-pressure mercury vapor discharge lamp as claimed in claim 1, characterized in that the translucent layer comprises an alkaline earth borate, and in that the thickness of the translucent layer is in the range from 0.1-50 μm.

5. A low-pressure mercury vapor discharge lamp as claimed in claim 4, characterized in that the translucent layer comprises SrB₄O₇.

6. A low-pressure mercury vapor discharge lamp as claimed in claim 4, characterized in that the thickness of the translucent layer is in the range from 10-20 μm.

7. A low-pressure mercury vapor discharge lamp as claimed in claim 1, characterized in that the discharge vessel is made from a glass comprising silicon dioxide and sodium oxide, with the glass composition comprising the following essential constituents, given in percentages by weight (wt. %):
60-80 wt. % SiO₂,
10-20 wt. % Na₂O.

8. A low-pressure mercury vapor discharge lamp as claimed in claim 8, characterized in that the glass composition includes the following constituents:
70-75 wt. % SiO₂,
15-18 wt. % Na₂O,
0.25-2 wt. % K₂O.

9. A low-pressure mercury vapor discharge lamp as claimed in claim 1, characterized in that a side of the translucent layer facing the discharge space is provided with a layer of a luminescent material.

10. A compact fluorescent lamp comprising a low-pressure mercury-vapor discharge lamp as claimed in claim 1, characterized in that a lamp housing is attached to the discharge vessel of the low-pressure mercury-vapor discharge lamp, which lamp housing is provided with a lamp cap.

11. A compact fluorescent lamp as claimed in claim 10, characterized in that the discharge vessel of the low-pressure mercury-vapor discharge lamp is surrounded by a light-transmitting envelope which is attached to the lamp housing.
